(19) United States
(12) Patent Application Publication
(10) Pub. No.: US 2010/0234502 A1
(43) Pub. Date: Sep. 16, 2010

(54) ADHESION PROMOTER AND CURABLE RESIN COMPOSITION

(75) Inventors: Isao IWASAKI, Annaka-shi (JP); Tsuneo Kimura, Annaka-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Shin-Etsu Chemical Co., Ltd., Chiyoda-ku (JP)

(21) Appl. No.: 12/720,101

(22) Filed: Mar. 9, 2010

(30) Foreign Application Priority Data
Mar. 13, 2009 (JP) 2009-061569

(51) Int. Cl. C08K 5/5419; C07F 7/10

(52) U.S. Cl. 524/188; 556/423

(57) ABSTRACT

An adhesion promoter obtained by reacting a secondary amino group-containing silicon compound represented by the general formula (1):

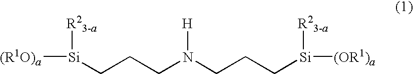

with an epoxy compound (B) represented by the following general formula (2):

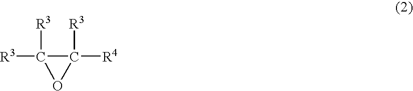

is provided. In the formulae, R¹ is an alkyl group, R² is a monovalent hydrocarbon group, a is 1, 2, or 3; R³ is the same or different hydrogen atom or an alkyl group, and R⁴ is a group represented by the general formula (3) or (4):

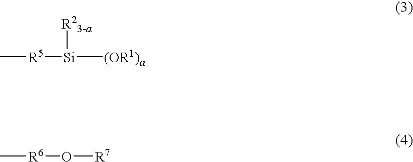

/wherein R¹ is an alkyl group, R² is a monovalent hydrocarbon group, R⁵ is an alkylene or alkyleneoxyalkylene group, R⁶ is an alkylene group, R⁷ is an alkyl, alkenyl, or acyl group, and a is 1, 2, or 3. The resin composition containing such adhesion promoter exhibits excellent durability of adhesion to glass as well as metals.

### CROSS-REFERENCE TO RELATED APPLICATION

This non-provisional application claims priority under 35 U.S.C. S119(a) on Patent Application No. 2009-061569 filed in Japan on Mar. 13, 2009, the entire contents of which are hereby incorporated by reference.

### TECHNICAL FIELD

This invention relates to a novel adhesion promoter and a curable resin composition containing this adhesion promoter. More specifically, this invention relates to an adhesion promoter which exerts an excellent adhesion property to metals such as aluminum and an excellent adhesion durability in hot water as well as a curable resin composition containing such adhesion promoter.

### BACKGROUND ART

Room temperature-curable organopolysiloxane compositions containing a diorganopolysiloxane terminated with a silanol group or an alkoxysilyl group, an alkoxysilane, an amino group-containing alkoxysilane, and a curing catalyst are known in the art. These compositions, however, suffered from the drawback that, when they are immersed in water for a long time, they are peeled off from the substrate such as float glass and figured glass having an active surface. Accordingly, these compositions can not be used for a structural sealant for structural adhesion system such as SSG system and SAG system or as a secondary sealant for a double-glazing glass where long term adhesion reliability as well as high load bearing capacity are required. It has been found that such peeling from the substrate having an active surface such as float glass becomes significant with the increase in the amount of the amino group-containing alkoxysilane added to the composition. However, a composition without the amino group-containing alkoxysilane suffered from utterly insufficient adhesion to metals such aluminum and resins while the composition enjoyed long term adhesion to the glass.

It has been known that adhesion durability of the organopolysiloxane composition in hot water can be improved by adding an epoxyalkylalkoxysilane to the composition, and Japanese Patent Publication Nos. 52-8854, 55-41702, 5-32397, and 7-113083 propose compositions containing a reaction product or a mixture of an aminoalkylalkoxysilane and epoxyalkylalkoxysilane for the purpose of improving adhesion and reliability of the adhesion. However, sufficient adhesion promotion is not accomplished by the methods described in these documents, and also, the room temperature-curable silicone composition containing such adhesion promoter occasionally exhibited poor storage stability and unexpected malfunction. To obviate such problems, Japanese Patent No. 3831481 proposes a method for producing an adhesion promoter in which 1.5 to 3.0 moles of epoxy compound is reacted with 1 mole of amino group-containing alkoxysilane in the presence of an alcohol to thereby selectively produce a novel carbasilatrane derivative which is useful as an adhesion promoter. However, in this reaction, the hydroxy group generated by the reaction between the amino group-containing alkoxysilane and the epoxy compound undergoes alcohol exchange reaction with the alkoxy group in the amino group-containing alkoxysilane to generate an alcohol such as methanol or ethanol, and the reaction has to be carried out at a temperature below the reflux temperature of the alcohol. Accordingly, a quite long time of more than 24 hours was necessary for the reaction to obtain the desired adhesion promoter, detracting from cost, productivity, and supply stability.

Other adhesion promoters which has the adhesion promoting effects equivalent to those of the silatrane compounds are isocyanurate-functional silane coupling agents such as tris[(trimethoxysilyl)propyl]isocyanurate and reaction products of an amino group-containing alkoxysilane and an isocyanate-functional silane coupling agent, which have been used as adhesion promoters. These isocyanurate-functional silane coupling agents and isocyanate-functional silane coupling agents are very expensive for use in an industrial scale, and these agents could be used only in limited applications.

### SUMMARY OF INVENTION

The present invention has been completed in view of the situation as described above, and an object of the present invention is to provide an inexpensive adhesion promoter which is to be added to a curable resin composition, and in particular, to a room temperature-curable organopolysiloxane composition for realizing a composition exhibiting an excellent adhesion property to metals without compromising the adhesion reliability to glass. The composition should also exhibit an excellent adhesion durability in hot water. Another object of the present invention is to provide a curable resin composition containing such an adhesion promoter.

In view of such situation, the inventors of the present invention made an intensive investigation, and found that an adhesion promoter exhibiting the desired performance can be readily obtained by reacting a particular amino group-containing silicon compound with an epoxy compound. The present invention is based on such finding.

Accordingly, the present invention provides an adhesion promoter and a curable resin composition containing such adhesion promoter as described below.

[1] An adhesion promoter obtained by reacting

(A) a secondary amino group-containing silicon compound represented by the general formula (1):

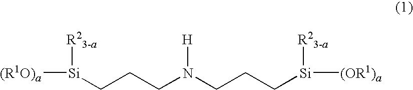

wherein R¹ is an alkyl group, R² is a monovalent hydrocarbon group, a is 1, 2, or 3; with

(B) an epoxy compound represented by the following general formula (2):

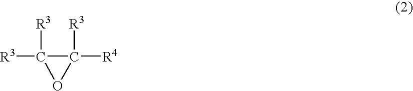

wherein R³ is the same or different hydrogen atom or an alkyl group, and R⁴ is a group selected from the group consisting of groups represented by the general formula (3) or (4):

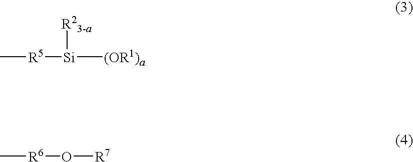

wherein R¹ is an alkyl group, R² is a monovalent hydrocarbon group, R⁵ is an alkylene group or an alkyleneoxyalkylene group, R⁶ is an alkylene group, R⁷ is an alkyl group, an alkenyl group, or an acyl group, and a is 1, 2, or 3.
[2] The adhesion promoter according to the above [1] wherein the component (A) is N,N-bis[(trimethoxysilyl)propyl]amine.
[3] The adhesion promoter according to the above [1] or [2] wherein the component (B) is 3-glycidoxypropyltrimethoxysilane.
[4] The curable resin composition comprising 0.01 to 20% by weight of the adhesion promoter of any one of the above [1] to [3].
[5] The curable resin composition according to the above [4] wherein the curable resin composition is a room temperature-curable organopolysiloxane composition.

### ADVANTAGEOUS EFFECTS OF INVENTION

The adhesion promoter of the present invention contains a novel compound, and this adhesion promoter can be produced efficiently in a wider range of reaction conditions compared to conventional adhesion promoters. The curable resin composition containing the adhesion promoter of the present invention exhibits an excellent durability of adhesion to glass, and in particular, an excellent adhesion durability in hot water as well as an excellent adhesion property to metals.

### BRIEF DESCRIPTION OF THE DRAWINGS

FIG. 1 is a chart showing the results of the ²⁹Si-NMR for the adhesion promoter A produced in Example 1.

FIG. 2 is a chart showing the results of the ¹³C-NMR for the adhesion promoter A produced in Example 1.

### DESCRIPTION OF EMBODIMENTS

The adhesion promoter of the present invention is obtained by reacting

(A) a secondary amino group-containing silicon compound represented by the general formula (1):

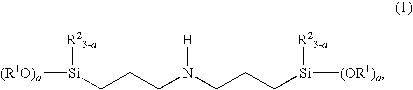

with

(B) an epoxy compound represented by the following general formula (2):

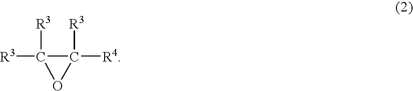

In the formula (1), R¹ is an alkyl group of preferably 1 to 6 carbon atoms, and in particular, 1 to 3 carbon atoms. Exemplary such alkyl groups include methyl group, ethyl group, propyl group, and butyl group, and the preferred are methyl group and ethyl group. R² is a monovalent hydrocarbon group of preferably 1 to 10 carbon atoms, and in particular, 1 to 8 carbon atoms. Exemplary such groups include alkyl groups such as methyl group, ethyl group, and propyl group; alkenyl groups such as vinyl group, allyl group, and butenyl group; and aryl groups such as phenyl group and tolyl group. The preferred is methyl group. In the formula (2), R³ is the same or different and is hydrogen atom or an alkyl group which may be selected from those mentioned for the R¹. Preferably, all R³ are hydrogen atom. R⁴ is a group selected from the group consisting of groups represented by the general formula (3) or (4):

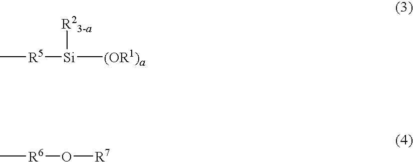

In the formula (3), R⁵ is an alkylene group or an alkyleneoxyalkylene group of preferably 1 to 12 carbon atoms, and more preferably 1 to 10 carbon atoms. For the R⁵, exemplary alkylene groups include methylene group, ethylene group, propylene group, butylene group, pentylene group, hexylene group, heptylene group, and octylene group; and exemplary alkyleneoxyalkylene groups include methyleneoxyethylene group, methyleneoxypropylene group, methyleneoxybutylene group, and ethyleneoxyethylene group, and the preferred are methylene group, ethylene group, and propylene group, and the most preferred is propylene group. R¹ and R² are as defined above. In the formula (4), R⁶ is an alkylene group of preferably 1 to 12 carbon atoms, and in particular, 1 to 10 carbon atoms. Exemplary such alkylene groups include methylene group, ethylene group, propylene group, butylene group, pentylene group, hexylene group, heptylene group, and octylene group, and the preferred is methylene group. R⁷ is an alkyl group, an alkenyl group, or an acyl group, and preferably those of 1 to 6 carbon atoms. For the R⁷, exemplary alkyl groups include methyl group, ethyl group, and propyl group, and exemplary alkenyl groups include vinyl group, allyl group, and butenyl group, and exemplary acyl groups include acetyl group, propionyl group, butyryl group, acryloyl group, and methacryloyl group. Preferably, R⁷ is allyl group or methacryloyl group. In the general formula (3), a is 1, 2, or 3, preferably 2 or 3, and most preferably 3.

Of the groups represented by the general formulae (3) and (4), the preferred is the one represented by the general formula (3).

The secondary amino group-containing silicon compound of the component (A) may be a commercially available product that has been used in the art for preparing a base polymer of a silyl group-terminated polyurethane. Exemplary such silicon compounds include N,N-bis[(trimethoxysilyl)propyl]amine, N,N-bis[(triethoxysilyl)propyl]amine, N,N-bis[(tripropoxysilyl)propyl]amine, N-(trimethoxysilyl)propyl-N-(triethoxysilyl)propylamine, N,N-bis[(methyldimethoxysilyl)propyl]amine, and N,N-bis[(dimethylmethoxysilyl)propyl]amine. The preferred are N,N-bis[(trimethoxysilyl)propyl]amine and N,N-bis[(triethoxysilyl)propyl]amine, and the most preferred is N,N-bis[(trimethoxysilyl)propyl]amine.

Exemplary epoxy compounds of the component (B) include 4-oxilanylbutyltrimethoxysilane, 8-oxilanyloctyltrimethoxysilane, 3-glycidoxypropyltrimethoxysilane, 3-glycidoxypropylmethyldimethoxysilane, 3-glycidoxypropyltriethoxysilane, allyl glycidyl ether, and glycidyl methacrylate. The preferred are 3-glycidoxypropyltrimethoxysilane and 3-glycidoxypropyltriethoxysilane, and the most preferred is 3-glycidoxypropyltrimethoxysilane.

The adhesion promoter of the present invention is obtained by reacting the component (A) with the component (B) preferably in the amount of 0.8 to 1.5 moles of the component (B) per mole of the component (A). When the proportion of the component (B) is insufficient, some of the component (A) will remain unreacted, and this may adversely affect the adhesion durability. On the other hand, excessive use of the component (B) may result in adverse effects such as poor storage stability in some applications due to the unreacted component (B). In either case, satisfactory effects as an adhesion promoter can be realized if a stripping step is included in the final step of the reaction procedure, while inclusion of such step may be economically disadvantageous in many cases. Accordingly, the component (B) is more preferably used at 0.9 to 1.1 moles per mole of the component (A).

The first step of this reaction is a nucleophilic addition reaction of secondary amino group of the component (A) to the epoxy ring of the component (B), and this reaction is followed by an alcohol exchange reaction of the hydroxy group generated by the addition reaction with the alkoxy group bonded to the silicon atom. While these reactions proceed at room temperature, the reaction is preferably conducted by heating up to a temperature of the lower boiling point of the components (A) or (B) for promotion of the reaction. Preferably, the reaction is conducted at 80 to 130° C.

The reaction step may be ended at the completion of the addition reaction, that is, at the time when either component (A) or the component (B) is substantially consumed in the reaction system. Alternatively, an additional step may be included at the end of the reaction step to remove the alcohol generated by the alcohol exchange reaction or the slight amount of the component (A) or the component (B) remaining from the reaction system at a reduced pressure and an elevated temperature. In most cases, the adhesion promoter obtained by the present invention will be a mixture of the addition product of the component (A) and the component (B) and the reaction product of the alcohol exchange reaction, and this mixture may be used with no further processing.

The adhesion promoter of the present invention may be used as an adhesion promoter for a curable organopolysiloxane composition such as a room temperature (condensation)-curable organopolysiloxane composition, an addition-curable organopolysiloxane composition, or a UV-curable organopolysiloxane composition; or for a curable resin composition such as an alkoxysilane-modified polyether curable composition, a curable polyurethane resin or rubber composition, a curable epoxy resin composition, a curable polysulfide resin composition, a curable unsaturated polyester resin composition; or alternatively, as a primer for improving the adhesion property of such curable resin composition by preliminarily coating on the surface of a metal, glass, or plastic substrate. The adhesion promoter of the present invention is most useful as an adhesion promoter for a curable organopolysiloxane composition such as a room temperature-curable organopolysiloxane composition, an addition-curable organopolysiloxane composition, or a UV-curable organopolysiloxane composition, and in particular, for a room temperature-curable organopolysiloxane composition.

The main feature of the curable resin composition of the present invention is that it contains the adhesion promoter as described above, while this adhesion promoter may be the adhesion promoter of the present invention or its mixture with other known adhesion promoter or known organic solvent. The content of the adhesion promoter in the curable resin composition of the present invention is not particularly limited, but is preferably 0.01 to 20% by weight, and more preferably 0.03 to 10% by weight.

A room temperature-curable organopolysiloxane composition is a preferred embodiment of the curable resin composition of the present invention. The room temperature-curable organopolysiloxane composition is not particularly limited as long as it is a condensation-curable organopolysiloxane composition. Example of the composition is one comprising

(i) 100 parts by weight of an organopolysiloxane containing at least 2 hydroxy groups and/or hydrolyzable groups bonded to the silicon atoms in a molecule;

(ii) 0.5 to 30 parts by weight of a silane containing at least 2 hydrolyzable groups in a molecule and/or its partial hydrolytic condensate; and

(iii) 0.01 to 20% by weight, and in particular, 0.03 to 10% by weight of the adhesion promoter in the composition.

In this composition, the organopolysiloxane of the component (i) is the main ingredient of the composition, and this organopolysiloxane (i) is a diorganopolysiloxane having both its ends capped with a hydroxysilyl group, an alkoxysilyl group, or an alkoxyalkoxysilyl group. This organopolysiloxane (i) preferably has a viscosity at 25° C. of 20 to 1,000,000 mPa·s since excessively low viscosity results in poor rubber elasticity after the curing while excessive viscosity leads to poor workability. More preferably, the viscosity is in the range of 100 to 100,000 mPa·s. Although this organopolysiloxane has substantially straight chain structure, the molecular chain may be partly branched. It is to be noted that the viscosity is the value measured by rotary viscometer.

Typical example of the component (i) is a diorganopolysiloxane represented by the following general formula (5):

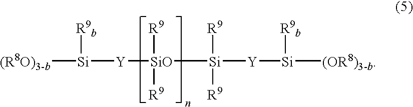

In formula (5), R⁸ is a group selected from hydrogen atom; an alkyl group of 1 to 10 carbon atoms such as methyl group, ethyl group, propyl group, butyl group, or octyl group; and an alkoxyalkyl group of 2 to 10 carbon atoms such as methoxymethyl group, methoxyethyl group, or ethoxymethyl group. Preferred are hydrogen atom, methyl group, or ethyl group. R⁹ is a group of 1 to 10 carbon atoms selected from a monovalent hydrocarbon group, a halogenenated monovalent group, and a cyanoalkyl group. Examples of the groups include an alkyl group such as methyl group, ethyl group, propyl group, butyl group, and octyl group; a cycloalkyl group such as cyclopentyl group and cyclohexyl group; an alkenyl group such as vinyl group and allyl group; an aryl group such as phenyl group, tolyl group, and naphthyl group; an aralkyl group such as benzyl group, phenylethyl group, and phenylpropyl group; a halogenated monovalent hydrocarbon group such as trifluoropropyl group and chloropropyl group; and a cyanoalkyl group such as β-cyanoethyl group and γ-cyanopropyl group. Among these, R⁹ is most preferably methyl group. When R⁸ is an alkyl group or an alkoxyalkyl group, b is 0 or 1, and when R⁸ is hydrogen atom, b is 2.

Y is an oxygen atom, a divalent hydrocarbon group of 1 to 6 carbon atoms, or a group represented by the following general formula (6):

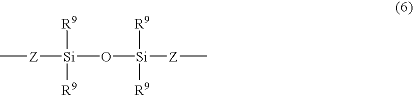

wherein R⁹ is as defined above and Z is a divalent hydrocarbon group of 1 to 6 carbon atoms.

In the formula (6), the divalent hydrocarbon group is preferably an alkylene group of 1 to 6 carbon atoms such as methylene group, ethylene group, propylene group, butylene group, or hexene group, and more preferably ethylene group. In the alkylene group, the hydrogen atom may be substituted with a monovalent hydrocarbon group such as methyl group. n is a number such that the viscosity at 25° C. is 20 to 1,000,000 mPa·s.

The component (i) may be produced by a method known in the art.

The silane and/or its partial hydrolytic condensate of the component (ii) is a component for curing the composition of the present invention and it should have at least 2 hydrolyzable groups bonded to the silicon atom in a molecule. Preferably, this component (ii) is the one represented by the following formula (7):

R′_{q}SiX_{4-q} (7)

wherein R′ is independently an unsubstituted or substituted monovalent hydrocarbon group of 1 to 6 carbon atoms, X is independently a hydrolyzable group, and q is an integer of 0 to 2.

Examples of the hydrolyzable group (X) are the same as those mentioned for the hydrolyzable group at the end of the molecular chain of the organopolysiloxane (i) excluding the hydroxy group, and the preferred are alkoxy group, ketoxime group, and isopropenoxy group.

The silane and/or its partial hydrolytic condensate of the component (ii) is not particularly limited as long as it has at least 2 hydrolyzable groups, and preferably at least 3 hydrolyzable groups in the molecule. The silicon atom may also bind to a group other than the hydrolyzable groups. The silane and/or its partial hydrolytic condensate of the component (ii) may have either silane or siloxane molecular structure, and in the case of the siloxane structure, it may have any of the straight chain, branched, or cyclic structures.

The group R′ other than the hydrolyzable group is an unsubstituted or substituted monovalent hydrocarbon group of 1 to 6 carbon atoms. Examples of the group include an alkyl group such as methyl group, ethyl group, propyl group, butyl group, pentyl group, and hexyl group; a cycloalkyl group such as cyclopentyl group and cyclohexyl group; an aryl group such as phenyl group and tolyl group; an aralkyl group such as benzyl group and 2-phenylethyl group; an alkenyl group such as vinyl group, allyl group, butenyl group, pentenyl group, and hexenyl group; and a halogenated alkyl group such as 3,3,3-trifluoropropyl group and 3-chloropropyl group. Among these, the preferred are methyl group, ethyl group, phenyl group, and vinyl group.

Examples of the silane and/or its partial hydrolytic condensate of the component (ii) of the present invention include ethyl silicate, propyl silicate, methyltrimethoxysilane, methyltriethoxysilane, vinyltrimethoxysilane, vinyltriethoxysilane, methyltris(methoxyethoxy)silane, vinyltris(methoxyethoxy)silane, methyltripropenoxysilane, methyltriacetoxysilane, vinyltriacetoxysilane, methyltri(methylethylketoxime)silane, vinyltri(methylethylketoxime)silane, phenyltri(methylethylketoxime)silane, propyltri(methylethylketoxime)silane, tetra(methylethylketoxime)silane, 3,3,3-trifluoropropyltri(methylethylketoxime)silane, 3-chloropropyltri(methylethylketoxime)silane, methyltri(dimethylketoxime)silane, methyltri(diethylketoxime)silane, methyltri(methylisopropylketoxime)silane, tri(cyclohexanoxime)silane, and their partial hydrolytic condensates, which may be used alone or in combination of two or more.

The component (ii) may be incorporated at an amount of 0.5 to 30 parts by weight, and preferably 1 to 10 parts by weight per 100 parts by weight the component (i). Incorporation at less than 0.5 part by weight may result in insufficient crosslinking, while incorporation in excess of 30 parts by weight may result in excessively hard product detracting from its economic advantage.

The composition of the present invention may have a catalyst for the purpose of promoting the curing, and the curing catalyst may be any catalyst which is used in a room temperature-curable composition that cures by condensation. Exemplary such catalysts include metal salts of an organic carboxylic acid such as lead 2-ethyloctoate, dibutyl tin dioctoate, dibutyl tin acetate, dibutyl tin dilaurate, butyl tin 2-ethylhexoate, iron 2-ethylhexoate, cobalt 2-ethylhexoate, manganese 2-ethylhexoate, zinc 2-ethylhexoate, tin caprylate, tin naphthenate, tin oleate, tin butanate, titanium naphthenate, zinc naphthenate, cobalt naphthenate, and zinc stearate; organic titanate esters such as tetrabutyl titanate, tetra-2-ethylhexyl titanate, triethanolamine titanate, and tetra(isopropenyloxy) titanate; organotitanium compounds and organotitanium chelates such as organosiloxytitanium, 3-carbonyltitanium, titanium diisopropoxybis(ethylacetoacetate), and titanium tetra(acetylacetonate); alkoxyaluminium compounds; aminoalkyl-substituted alkoxysilanes such as 3-aminopropyltriethoxysilane and N-(trimethoxysilylpropyl)ethylenediamine; amine compounds such as hexylamine and dodecylamine phosphate; lower fatty acid salts of an alkaline metal such as potassium acetate, sodium acetate, and lithium oxalate; dialkylhydroxylamines such as dimethylhydroxylamine and diethylhydroxylamine; and guanidyl-containing silane and siloxane represented by the following formulae:

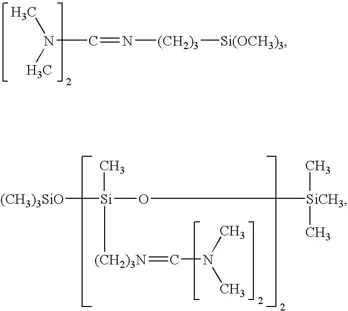

which may be used alone or in combination of two or more.

The amount of such curing catalyst is not particularly limited, and a catalytically effective amount may be used. The curing catalyst, however, is typically used at 0.01 to 20 parts by weight, and in particular, 0.1 to 10 parts by weight per 100 parts by weight of the component (i). When the content of the catalyst is insufficient, sufficient effect of the addition of the catalyst may not be realized, while excessive addition may lead to poor storage stability of the resulting composition.

The composition of the present invention may also contain a filler for the purpose of reinforcement or filling. Exemplary fillers include silica, quartz, diatomaceous earth, titanium oxide, aluminum oxide, lead oxide, iron oxide, carbon black, bentonite, graphite, calcium carbonate, mica, clay, glass beads, glass microballoons, shirasu balloons, glass fiber, polyvinyl chloride beads, polystyrene beads, and acryl beads.

The amount of the filler is not particularly limited. The filler, however, is typically used at 1 to 300 parts by weight, and in particular, at 5 to 200 parts by weight per 100 parts by weight of the component (i). When the amount of the filler is insufficient, the effect of adding the filler may prove insufficient, while excessive filler addition may invite unduly high viscosity of the composition, and hence, poor workability in the mixing and using.

The composition used in the present invention may optionally contain additives such as a plasticizer, a colorant such as a pigment, a flame retardant, a thixotropic agent, a bacteriocide or fungicide, a so-called carbon functional silane having amino group, epoxy group, thiol group, or the like (such as γ-glycidoxypropyltrimethoxysilane and aminopropyltriethoxysilane) in an amount without adversely affecting the objectives of the present invention.

### EXAMPLES

Next, the present invention is described by referring to Examples and Comparative Examples which by no means limit the scope of the present invention. In the Examples, viscosity is the value measured at 25° C., and parts are parts by weight.

### Example 1

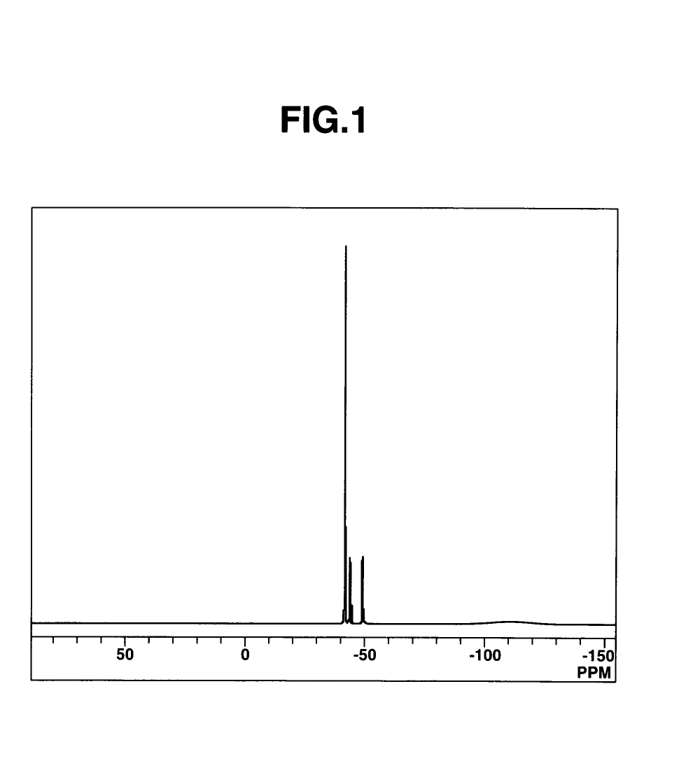

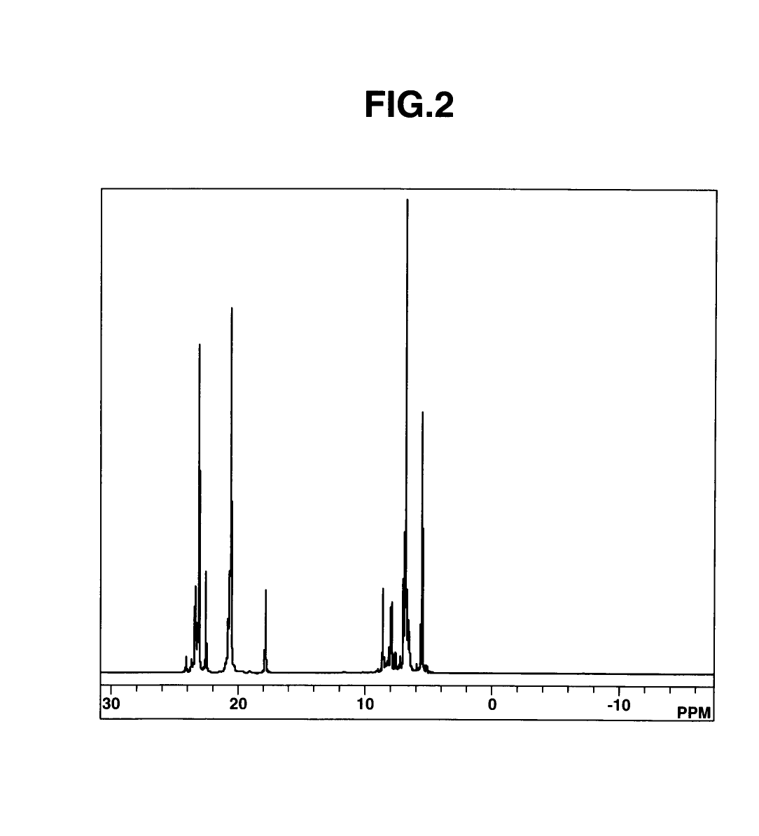

To a four necked flask equipped with a nitrogen-inlet tube, a reflux condenser, an agitator, and a thermometer, 591 g (1.73 mole) of N,N-bis[(trimethoxysilyl)propyl]amine and 409 g (1.73 mole) of 3-glycidoxypropyltrimethoxysilane were added, and the mixture was heated to 120° C. for 4 hours with stirring. The pressure in the interior of the reaction vessel was reduced to up to 10 mmHg at 120° C., and low boiling components such as alcohols were distilled off for 2 hours. After cooling to the room temperature, the pressure was raised to normal pressure to collect the reaction product which was pale yellow liquid having a viscosity of 74 mPa·s measured by rotary viscometer. This product was designated adhesion promoter A. The adhesion promoter A was analyzed by ¹³C-NMR and ²⁹Si-NMR. The resulting spectra are shown in FIGS. 1 and 2. The products were confirmed to include compound X having a secondary amino group of the N,N-bis[(trimethoxysilyl)propyl]-amine added to epoxy group of the 3-glycidoxypropyltrimethoxy-silane, and compound Y formed by intramolecular cyclization through intramolecular alcohol exchange reaction of hydroxyl group generated by cleavage of the epoxy group with the methoxy group bonded to the silicon atom. The structural formulae of the compound X and the compound Y are shown below.

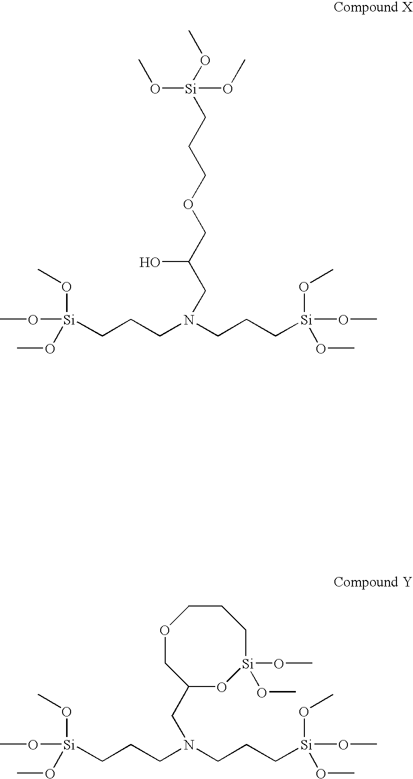

### Example 2

341 g (1.0 mole) of N,N-bis[(trimethoxysilyl)propyl]-amine and 236 g (1.0 mole) of 3-glycidoxypropyltrimethoxy-silane were placed in a 1 liter glass bottle, and with the bottle sealed, the mixture was shaken for homogeneous mixing and allowed to stand for 60 days. The product was pale yellow liquid having a viscosity of 24 mPa·s measured by a rotary viscometer. This product was designated adhesion promoter B.

### Example 3

To 100 parts of polydimethylsiloxane having both ends capped with hydroxy group and having a viscosity of 5,000 mPa·s was added 100 parts of colloidal calcium carbonate powder (Carlex 300 manufactured by Maruo Calcium), and the mixture was homogeneously mixed by using three-roll mill. This mixture was used as the main ingredient.

In the meanwhile, to 25 parts of polydimethylsiloxane having both ends capped with trimethylsiloxy group and having a viscosity of 5,000 mPa·s were added 10 parts of carbon black, 30 parts of 1,1,3,3-bis[(trimethoxysilyl)ethyl]disiloxane, 3 parts of N-(2-aminoethyl)-3-aminopropyltrimethoxysilane, and 0.1 part of dimethyl tin dineodecanoate. To this mixture was also added 7 parts of adhesion promoter A produced in Example 1. This mixture was designated curable resin composition, and the main ingredient and this curable resin composition were mixed at a weight ratio of 10:1 to produce a room temperature-curable organopolysiloxane composition.

### Example 4

A room temperature-curable organopolysiloxane composition was prepared by the same method of Example 3 except that the adhesion promoter B prepared in Example 2 was used instead of the adhesion promoter A.

### Comparative Example 1

A room temperature-curable organopolysiloxane composition was prepared by the same method of Example 3 except that the adhesion promoter A was not added.

### Comparative Example 2

A room temperature-curable organopolysiloxane composition was prepared by the same method of Example 3 except that the adhesion promoter A was not added and 10 parts of N-(2-aminoethyl)-3-aminopropyltrimethoxysilane was used instead of 3 parts of the N-(2-aminoethyl)-3-amino-propyltrimethoxysilane.

Next, the room temperature-curable organopolysiloxane compositions prepared in each of the Examples 3 and 4 and the Comparative Examples 1 and 2 were evaluated for their adhesion property to aluminum and durability of adhesion to a float glass plate in hot water by the procedure as described below.

### [Evaluation of Adhesion to Aluminum]

The resulting room temperature-curable organopolysiloxane compositions were evaluated by their adhesion property to the aluminum test piece according to JIS H 4000 A1050P. A test piece for simplified test was prepared according to JASS8 (Japanese Architectural Standard Specification JASS 8 Waterproofing and Sealing). The test piece was prepared in a constant temperature and humidity chamber at a temperature of 23° C. and a relative humidity of 50%, and left in the chamber for 24 hours. A simplified adhesion test was conducted by holding the cured product with fingers and pulling in 180° directions. The adhesion property was evaluated “good” when the cured product of the room temperature-curable organopolysiloxane was not peeled from the aluminum surface, or “poor” when the cured product underwent cohesive failure.

### [Evaluation of Adhesion Durability in Hot Water]

A H-shaped block was prepared by using the resulting room temperature-curable organopolysiloxane composition and a float glass plate to which the composition was adhered according to JIS A 1439. This H-shaped block was allowed to stand in an atmosphere of 23° C. and a relative humidity of 50% for 7 days, and then, in a dryer maintained at 50° C. for 7 days. This H-shaped block was evaluated for its tensile adhesion at a tensile speed of 50 mm/min. by visually observing the fracture surface of the cured product after the test. This results were used for the initial data. Next, the remaining H-shaped blocks were subjected to accelerated deterioration test by immersing in hot water at 80° C. for 28 days to thereby evaluate the long term adhesion durability in water. After removing from the hot water, the blocks were subjected to the tensile test as in the case of the initial test, and evaluated by visually observing the fracture surface of the cured product after the test. This results were used as the data after the immersion in hot water. The fracture surface was evaluated by visually examining the percentage of the area where cohesive failure of the cured product had occurred. More specifically, the percentage of cohesive failure was 100% when cohesive failure of the cured product had occurred in the entire fracture surface, and this indicated “good” adhesion, while the percentage of cohesive failure was 0% when the entire fracture surface was interfacial peeling. In this case, the adhesion was “poor”.

The results of the evaluation of the adhesion property to aluminum and the durability of adhesion to a float glass plate in hot water are shown in Table 1.

TABLE 1

| | | | | Comparative | |
|---|---|---|---|---|---|
| | | Example | | Example | |
| | | 3 | 4 | 1 | 2 |
| Adhesion to aluminum | Adhesion | Good | Good | Poor | Good |
| (after 24 hours) | | | | | |
| Durability of adhesion | CF | 100 | 100 | 100 | 0 |
| in hot water | (%) | | | | |
| (after 28 days at 80° C.) | | | | | |

### Comparative Example 3

A room temperature-curable organopolysiloxane composition was prepared by the same method of Example 3 except that 2.9 parts of 3-glycidoxypropyltrimethoxysilane and 4.1 parts by weight of a N,N-bis[(trimethoxysilyl)-propyl]amine were used instead of the 7 parts of the adhesion promoter A. The mixture became viscous and cured while mixing, and the test piece for the evaluation of the adhesion to aluminum and the durability of adhesion to a float glass plate in hot water could not be prepared.

### Example 5

A room temperature-curable organopolysiloxane composition was prepared by the same method of Example 3 except that 3-aminopropyltrimethoxysilane was used instead of the N-(2-aminoethyl)-3-aminopropyltrimethoxysilane.

### Example 6

A room temperature-curable organopolysiloxane composition was prepared by the same method of Example 3 except that 3-(N-aminomethylbenzylamino)propyltrimethoxysilane was used instead of N-(2-aminoethyl)-3-aminopropyltrimethoxy-silane.

### Example 7

A room temperature-curable organopolysiloxane composition was prepared by the same method of Example 3 except that 3-aminopropyltriethoxysilane was used instead of N-(2-aminoethyl)-3-aminopropyltrimethoxysilane.

### Comparative Example 4

A room temperature-curable organopolysiloxane composition was prepared by the same method of Example 5 except that the adhesion promoter A was not added.

### Comparative Example 5

A room temperature-curable organopolysiloxane composition was prepared by the same method of Example 6 except that the adhesion promoter A was not added.

### Comparative Example 6

A room temperature-curable organopolysiloxane composition was prepared by the same method of Example 7 except that the adhesion promoter A was not added.

The room temperature-curable organopolysiloxane compositions produced in Examples 5 to 7 and Comparative Examples 4 to 6 were evaluated for their adhesion property to aluminum and durability of adhesion to a float glass plate in hot water by the procedure as described above. The results are shown in Table 2.

TABLE 2

| | | | | | Comparative | | |
|---|---|---|---|---|---|---|---|
| | | Example | | | Example | | |
| | | 5 | 6 | 7 | 4 | 5 | 6 |
| Adhesion to aluminum | Adhesion | Good | Good | Good | Poor | Poor | Poor |
| (after 24 hours) | | | | | | | |
| Durability of adhesion | CF | 100 | 100 | 100 | 0 | 100 | 0 |
| in hot water | (%) | | | | | | |
| (after 28 days at 80° C.) | | | | | | | |

As demonstrated in the Examples and Comparative Examples, the adhesion promoter of the present invention can be readily produced, and the curable resin composition containing the adhesion promoter exhibits an excellent durability of adhesion to glass, and in particular, an excellent durability of adhesion in hot water as well as swift adhesion to metal.

Japanese Patent Application No. 2009-061569 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An adhesion promoter obtained by reacting
(A) a secondary amino group-containing silicon compound represented by the general formula (1): 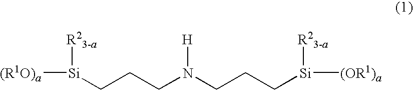
wherein R¹ is an alkyl group, R² is a monovalent hydrocarbon group, a is 1, 2, or 3; with
(B) an epoxy compound represented by the following general formula (2): 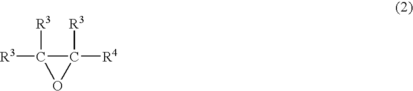
wherein R³ is the same or different hydrogen atom or an alkyl group, and R⁴ is a group selected from the group consisting of groups represented by the general formula (3) or (4): 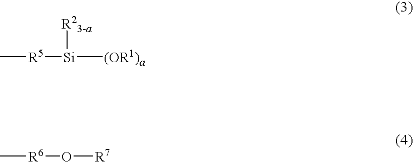
wherein R¹ is an alkyl group, R² is a monovalent hydrocarbon group, R⁵ is an alkylene group or an alkyleneoxyalkylene group, R⁶ is an alkylene group, R⁷ is an alkyl group, an alkenyl group, or an acyl group, and a is 1, 2, or 3.

2. The adhesion promoter according to claim 1 wherein the component (A) is N,N-bis[(trimethoxysilyl)propyl]amine.

3. The adhesion promoter according to claim 1 wherein the component (B) is 3-glycidoxypropyltrimethoxysilane.

4. The curable resin composition comprising 0.01 to 20% by weight of the adhesion promoter of claim 1.

5. The curable resin composition according to claim 4 wherein the curable resin composition is a room temperature-curable organopolysiloxane composition.
